(19) United States
(12) Patent Application Publication
(10) Pub. No.: US 2013/0091467 A1
(43) Pub. Date: Apr. 11, 2013

(54) SYSTEM AND METHOD FOR NAVIGATING MENU OPTIONS

(71) Applicant: barnesandnolble.com llc, New York, NY (US)

(72) Inventors: Matthew PALLAKOFF, Mountain View, CA (US); Luis Daniel MOSQUERA, Foster City, CA (US)

(73) Assignee: BARNESANDNOBLE.COM LLC, New York, NY (US)

(21) Appl. No.: 13/645,389

(22) Filed: Oct. 4, 2012

Related U.S. Application Data
(60) Provisional application No. 61/545,074, filed on Oct. 7, 2011.

(51) Int. Cl. G06F 3/048

(52) U.S. Cl. 715/835

(57) ABSTRACT

A system and a method for performing an action with respect to an item selected by a user on a display screen of an electronic device. In a preferred embodiment, the display screen is a touchscreen and the user selects an item, e.g., a portion of text or a file by touching a thumb or finger down on the item. The user pauses very briefly before dragging the item. After the pause, a small icon representing the selected item appears and a first row of options appears just above or below the item. This first row of options contains the various functions that can be performed with the item. The user then drags the item to the option which she would like to perform. As the icon of the item being dragged by the user reaches the desired option, a second set of sub options, if any, associated with the first option appears. This process can be repeated for as many levels of sub options that exist for the particular action to be performed on the selected item.

### CROSS-REFERENCE TO RELATED APPLICATION

This application claims benefit of U.S. Provisional Application No. 61/545,074, filed Oct. 7, 2011, which is hereby incorporated by reference.

### FIELD OF THE INVENTION

The present invention generally relates to systems and methods for interacting with user interfaces, and more particularly to systems and methods for making selections in context menus, dropdown menus and dialog boxes.

### BACKGROUND OF THE INVENTION

In most operating systems, performing an action on book covers, text, and other objects tends to require quite a few taps, typically on touch screens, through a sequence of menus, drop down boxes and dialog boxes in order to execute the desired action. For example, to post a quote from an eBook to the user's Facebook™ wall, or recommend an eBook from the user's library requires a series of taps through a sequence of menus. Although the conventional method of navigating these menus is self-explanatory, the user's actions are not fluid or quick.

In other conventional menu systems, the menu option are expanded sideways and downward as users make selections. Other menu systems are “flower” or circular shaped multi-level structures.

### SUMMARY OF THE INVENTION

The system and method of the present invention is alternative to the conventional system and method and is more akin to drag-and-drop operations, allowing swifter actions with less motion and effort. The user can either drag through options, or tap through options. In a preferred embodiment, the present invention is operated on a mobile device with a touch screen

A user initiates the process of performing an action with respect to a book cover or other item (e.g., a selection of text or some other object) by touching a thumb or finger down on the item. The user pauses briefly before dragging the item (perhaps as short as 1/10th second but ideally long enough for the system to recognize that this gesture is not merely a tap). After the pause, a small icon representing the selected item appears (“shrinking” clown from the selected item) and a first row of options appears, preferably, above the item. This first row of options contains the various functions that can be performed with the item (e.g., recommend an eBook to a friend). The user then drags the item to the option which she would like to perform. As the icon of the item being dragged by the user reaches the desired option, a second set of sub options, if any, associated with the first option appears. As the second set of sub options appears, the first set of options shrinks, but is still visible so that the user can determine how she has navigated to the second set of options. This process can be repeated for as many levels of sub options that exist for the particular action to be performed on the selected item.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIGS. 1A-1E illustrate an example of the use of the present invention for posting a quote from an eBook to a Facebook wall;

FIGS. 2A-2G illustrate an example of the use of the present invention for recommending an eBook to user's contact;

FIG. 3 illustrates a flow chart according to the basic operation of the present invention; and

FIG. 4 illustrates an electronic device incorporating the present invention.

### DETAILED DESCRIPTION OF THE INVENTION

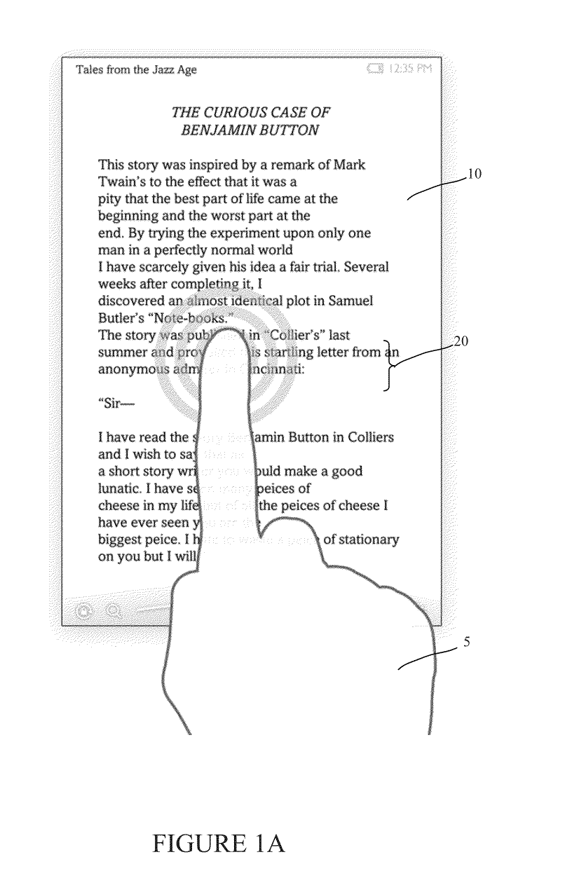

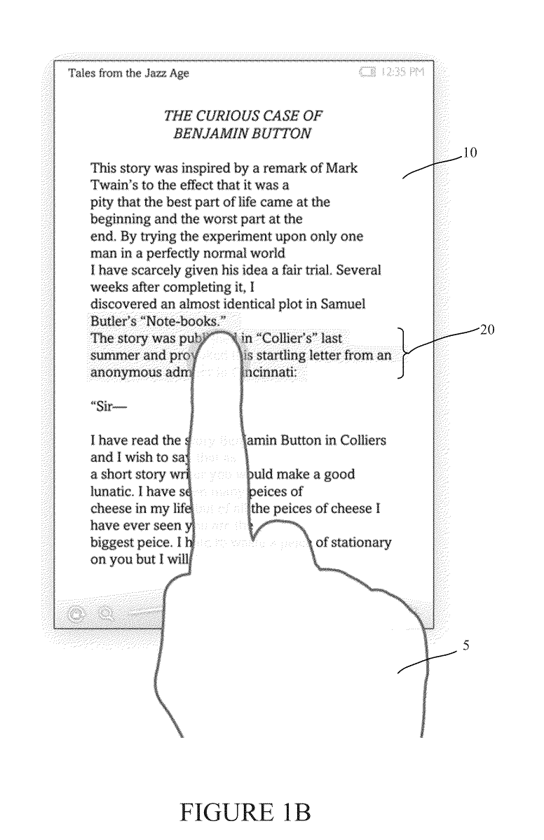

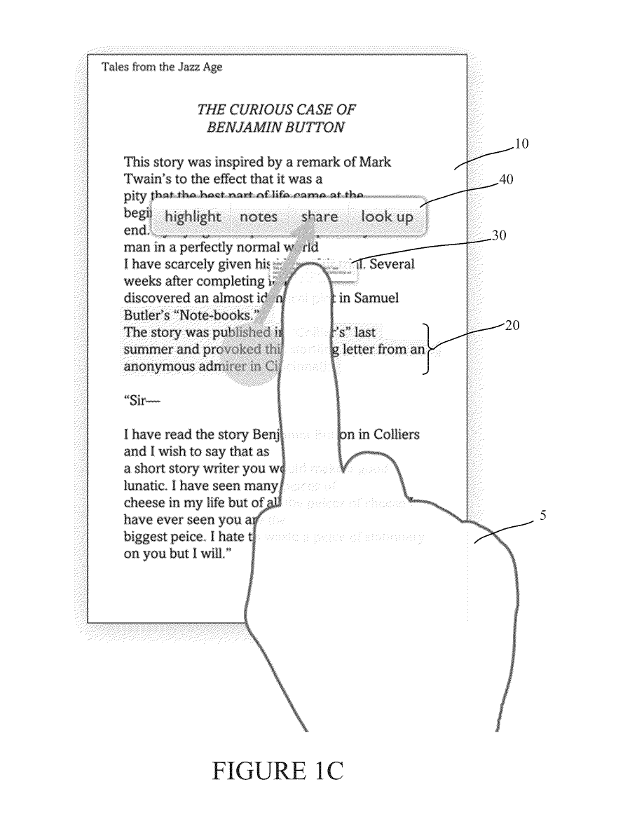

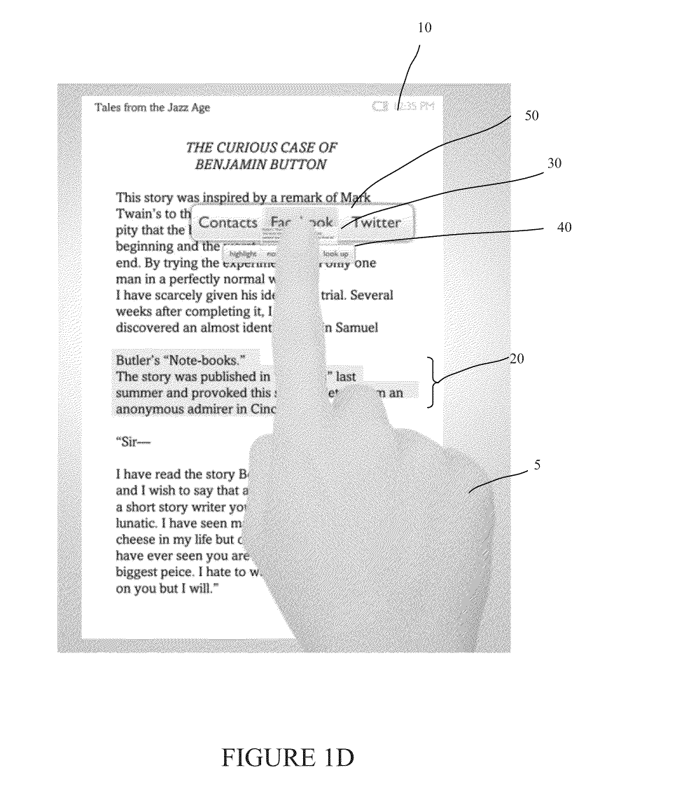

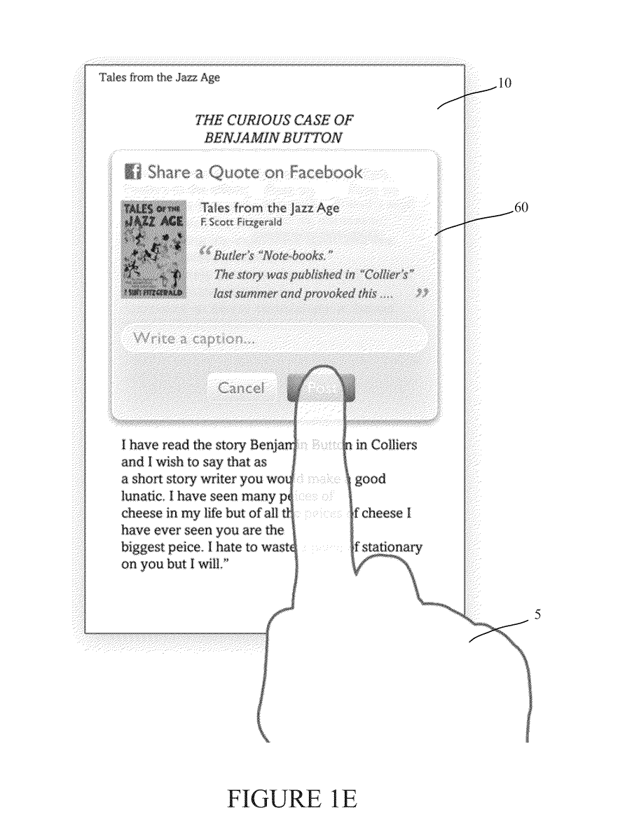

FIGS. 1A-1E illustrate a first example of the use of the present invention. The specific example illustrated in these figures is a user 5 posting a quote from an eBook 10 to a Facebook wall. This example of the present invention illustrates the preferred embodiment in which the user 5 drags the selection through the various options, as opposed to an alternative embodiment where the user can use “tapping” gestures on a touch screen to navigate the through the options. The present invention can be embodied either in a “drag-through-options” or a “tap-through-options” embodiment. Although in the preferred embodiment of the present invention, the user executes the actions described herein using her fingers and a touch screen device, as appreciated by those skilled in the art, the present invention is equally executable by other user input devices such as a mouse, track pad or joystick. However, the present invention is particularly well suited for the ergonomics associated with operating a hand held tablet or other mobile device using fingers

Drag-Through-Options Mode

As shown in FIG. 1A, a user 5 selects a section of text 20 in an eBook 10. In one embodiment, the user can make this selection of text 20 by quickly tapping three times on the desired text, also known as triple-tapping. As appreciated by those skilled in the art, the initial selection of text, or other object, can be accomplished by several other processes or mechanisms.

As shown in FIG. 1B, the user 5 initiates the dragging of the selected text 20 by touching a thumb or finger down on the selected text 20 and pausing briefly before dragging (perhaps as short as 1/10th second, but long enough for the system to distinguish the gesture from a mere tap). Again, as appreciated by those skilled in the art, this selection and dragging of the item can be accomplished by other input mechanisms, such as with a mouse.

As shown in FIG. 1C, after this brief pause, while the thumb or finger is still pressing the selected text 20, the first row 40 of menu options appears. In addition, in a preferred embodiment, a small icon 30 representing the selected item 20 appears. In the preferred embodiment, the small icon 30 visually looks like a “shrunken” version of the selected item, e.g., the selected text 20. This is an optional feature. Other embodiments of the present invention display a circle or an X or even nothing under the user's finger as she drags. However in the preferred embodiment, semi-transparent icon 30 that looks like the item that the user is dragging, e.g., the cover of an eBook or the section of text that user wishes to share on Facebook™. In this preferred embodiment, the icon 30 is preferably semi-transparent so the user can see the menus underneath the icon 30.

In a preferred embodiment, the first row 40 of menu options appears just a little above the point at which the user's finger was pressed down on the touch sensitive input device, e.g., touch screen. In an alternative embodiment, the first row 40 of menu options appears near or just a little above the top of the selected item 20. Alternative embodiments may position the first row 40 of menu options below the point at which the finger pressed down. However, in this alternate embodiment, the user's hand 5 or fingers may obscure the menu options. Accordingly, this embodiment is not recommended for cases where there is room available above the point at which the user's finger pressed down.

In the preferred embodiment, the menu 40 is brought up after the user 5 presses the selected item 20 and briefly keep pressing the item 20 without sliding or lifting her finger. If user just quickly taps, without keeping her finger down and fairly still for some minimal length of time, which can be as little as 1/10th second, then the menu 40 preferably does not appear. If the user immediately starts dragging the item without first holding her finger fairly still for that minimal hold time, then the menu preferably does not appear. Once the menu 40 appears, the user can drag the item 20 to the options as described below.

The row 40 of menu options is the first level of actions than can be taken with respect to the selected item 20. In the present example, as shown in row 40, the user 5 can choose to “highlight” the selected text, add “notes” at the position in the eBook of the selected text, “share” the selected text, or perform a “look up” with respect to the selected text, e.g., a dictionary definition look up of a selected word. In the present example, the user is going to “share” the selected text 20.

As seen in FIG. 1D, as the user drags the icon 30 onto the “share” option on menu 40, a second set of sub options 50 associated with the “share” option on row 40 appears. In a preferred embodiment, the second set of sub options 50 appears in a row just a little above the first row 40. As layer 50 appears, the previous layer 40 is preferably displayed as shrunk down in size. In a preferred embodiment of the present invention, when a second row of sub options appears, the first row of options shrinks. When a third row of options appears, the second one shrinks and the first one may shrink even further. In an alternative embodiment where the first row 40 of menu options appears below the point at which the user's finger pressed down, a second row of sub options appears below the first row, and a third row of options appears below the second row. But as noted, in preferred embodiments the bubbles, i.e., the rows of options, grow upwards when there is room, so that the user's hand 5 is less likely to obscure the displayed options.

In the particular sharing example shown in FIG. 1D, the user is presented with the sub options on row 50 of sharing the selected text to someone on their Contacts list, via Facebook™ or via Twitter™. As appreciated by those skilled in the art, the sub options presented on a particular new row are related to the option selected on a previous row. For example, if, on a previous row a user had selected a “STORE” option with respect to a particular object, the new row might give the user several selectable options as to where the object might be stored.

In the present example shown in FIG. 1D, the user selects to share the selected text on her Facebook™ wall by lifting her finger on the Facebook™ option on row 50. In response to the user 5 “dropping” the text item on the Facebook™ option on row 50, as shown in FIG. 1E, a pop-up screen 60 is displayed to enable her to complete the posting of the quote to her Facebook™ wall.

To enter the drag-though-option mode embodiment of the present invention, the user presses-and-briefly-pauses on an item, e.g., an area of selected text, a word, a book cover, a file icon, to bring up the first row 40 of menu items, then drags the selected item more than some minimal distance, e.g., 1/10th inch in any direction. The system of the present invention interprets this user action as an intention to enter the drag-through-options mode. Once the system has detected the user action, a flag can be set indicating the user is in the drag-through-options mode, as opposed to the tap-through-options mode described below.

In a preferred embodiment, once the system is in drag-through-options mode, if the user “drops” the item on an option that is not executable because that option leads to an additional row of bubbles (such as the “share” option in the example above) or if the user “drops” the item outside of any of the bubble options—then the layers of bubbles simply disappear for (“pop”) without any action being taken. If the user drops the item on an option that does not lead to an additional row of bubbles, then it is an executable option, which can also be referred to as a “leaf” bubble. Leaf bubbles generally represent an action to be taken on the object being dragged. Dropping an item on the leaf bubble will initiate taking that action. In same cases, this may involve displaying a dialog or other UI element that the user can use to provide more information to proceed with performing that action, such as in the “Facebook™” share action described above.

Once the system is in the drag-through-options mode, the user can drag the item to any option in the initial row 40 of selectable options/actions/functions. These options are also known as “action bubbles,” and represent actions that can be invoked with respect to the item that is being dragged. For example, if the item is a section of text in an eBook, the first level 40 of action bubbles would represent actions that can be executed with respect to the selected text, such as sharing the text, as illustrated in FIGS. 1C-1D. The designers of the system can predetermine which first level actions are included on the first row of bubbles that appear with respect to particular types of items when the user enters the drag-through-options mode. Similarly, the designers determine the actions included in the second and third (or greater) level of bubbles. In an alternative embodiment, the user can customize the actions that appear at the various levels. For example, if the user only uses Facebook™ to post selected text, she can customize the bubbles to include a “Share to Facebook™” on the first level of bubbles, thereby reducing the number of drag-through levels of bubble rows she needs to traverse to perform this sharing function.

In preferred embodiments, if a row of action bubbles will not fit within the width of the device given the preferred font size and action-bubble sizing and the given the device's size and orientation, the system will automatically move the options that don't fit in this level of action bubbles to a higher level If this occurs, the system introduces a “more . . . ” action bubble into this level of action bubbles that, when invoked, opens the higher level of action bubbles containing the options that did not fit.

As described above, in the preferred embodiment of the drag-through-options mode, as the user drags up to a second or third row of options, the previous row remains visible, but shrinks in size. In the preferred embodiment, if the user is on or above any row except the first row, and then drags her finger (dragging the item) back down below that row, then that row disappears and the previous row enlarges again. In the preferred embodiment, if the user drags the item below the first row, the first row remains visible and in its original size, until the user lifts her finger. In this preferred embodiment, if the user lifts her finger while not touching any item in any row, all existing bubbles/row disappear. In an alternative embodiment, a “pop” visual and/or audio effect can be executed when the bubbles disappear.

Shrinking the menu levels as described above is an element that helps conserve screen space on tablets. In alternative embodiments, the first level can be shrunk once the user has reached the second menu level. However, the second level is not necessarily shrunk when the user gets to the third level.

As described above, in the preferred embodiment, the rows of menu item “grows” upward from the user's touch on the screen. In the prior art the menus typically grew sideways and/or downward. Most user interface designers find it counter-intuitive to grow upward, in part because people read side to side and top to bottom (in all languages). People don't read bottom to top in any language. The circular or flower shaped menu structures described above are awkward to read and use. On mouse-based systems, growing sideways or down is acceptable and is the reason why it is the standard for desktop/laptop OSs. However, in the context of a touch-based tablet or handset, if a multi-level menu grow sideways or down, the user's hand would often obscure each new layer of menu options that appears.

By growing the bubbles upward in the preferred embodiment, the present invention solves the problem of the user's hand obscuring the next level of options. This upward growth allows the user to slide through the multi-level menu options. It has been found that having the user sliding the selected item though the menu options is quite a bit quicker and easier than tapping through sequences of menus and panels/dialogs.

Although the present invention can be used in a tap-though mode, as described below, in the context of a touch screen device, a user can slide a finger or thumb much more accurately than he or she can tap. One way to see this is to open an email or note full of text on a device with an insertion point magnifier, in which a user slides her finger left or right to position the insertion cursor at any letter she wants. The user's finger precisely moves the cursor tiny distances, well below 1/20th of an inch, to move the cursor left or right over the letter.

In contrast, if the user tries tapping the screen on the device to insert the cursor at a specific spot in the text, the user will most often miss the spot. In general, users can only accurately tap with about ¼th inch resolution with an index finger, due to the need to use your entire arm to position the finger. Using a thumb, the user can position a spot to only within ⅜th inch, due to the size and shape of thumbs and the necessity of using the user's other fingers to hold the back of the device stable.

With the preferred drag through embodiment of the present invention, the embodiment allows users employ the more accurate positioning technique of sliding rather than tapping. Further the sliding motion contributes to the effortless feel of the gesture. This embodiment takes less work to accurately choose the menu options.

Tap-Through-Options Mode:

In addition to the drag-through-options embodiment described above, the present invention also provides a tap-through-options mode in which a user can tap her way through the options, rather than dragging the selected item. Again, as appreciated by those skilled in the art, the tapping actions described herein can be accomplished by other input mechanisms, such as with a mouse. To enter the tap-through-options mode, the user selects an object, e.g., by tapping three time on a portion of text as described above, and then presses her finger briefly on the item. In response to this selection of an item, the system displays the first row of options/bubbles. The user then lifts her finger off of the selected item without dragging (e.g., without moving more than, say, 1/10th inch). After the user lifts her finger, the system continues to display the first row of options. The user can then tap on one of the options on the visible row in order to execute the action associated with the option, or bring up a second row of options as described above. Visually, the rows/bubbles look the same as they do in the drag-through-options mode described above, however the user taps through the options instead of dragging the selected item.

Once the user has entered the tap-through-options mode, by pressing and briefly-pausing on an item, the user can cancel the operation by “tapping out,” i.e., by tapping anywhere outside of the set of bubbles or the original item. This will cause the system to exit the tap-though-options mode.

Some users may prefer to tap their way through the options. However, the drag-through-options mode allows the user to slide the item through the options. Since dragging motion does not require any lifting and carefully repositioning a finger many times, this motion may be preferred by most users. Poking at items on a screen (e.g., a tablet) that's too big to operate exclusively with thumbs requires a surprising amount of muscle strength and control. Almost every joint and muscle from the shoulder to the finger tip is involved in each poke. Further, users are generally more precise when sliding a finger or thumb between two nearby items than they are when tapping one item and then the other.

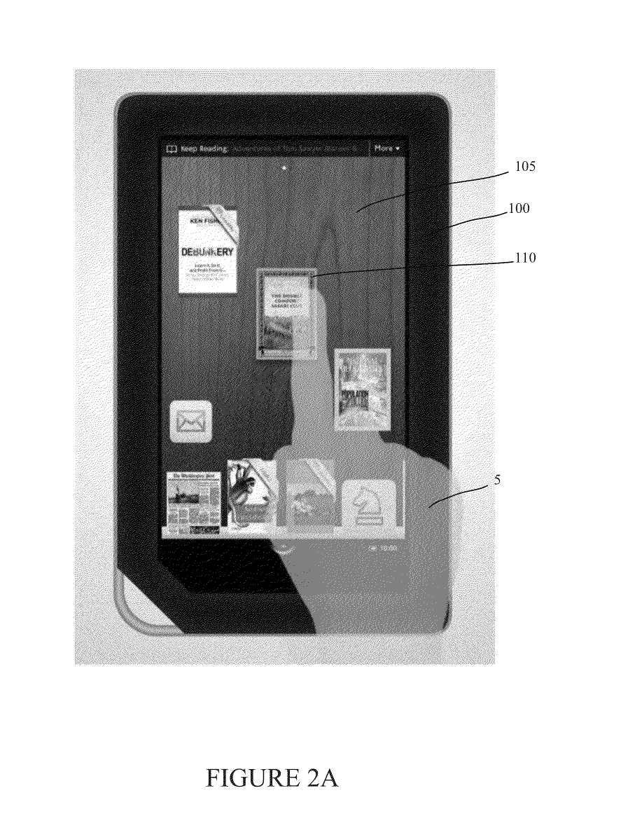

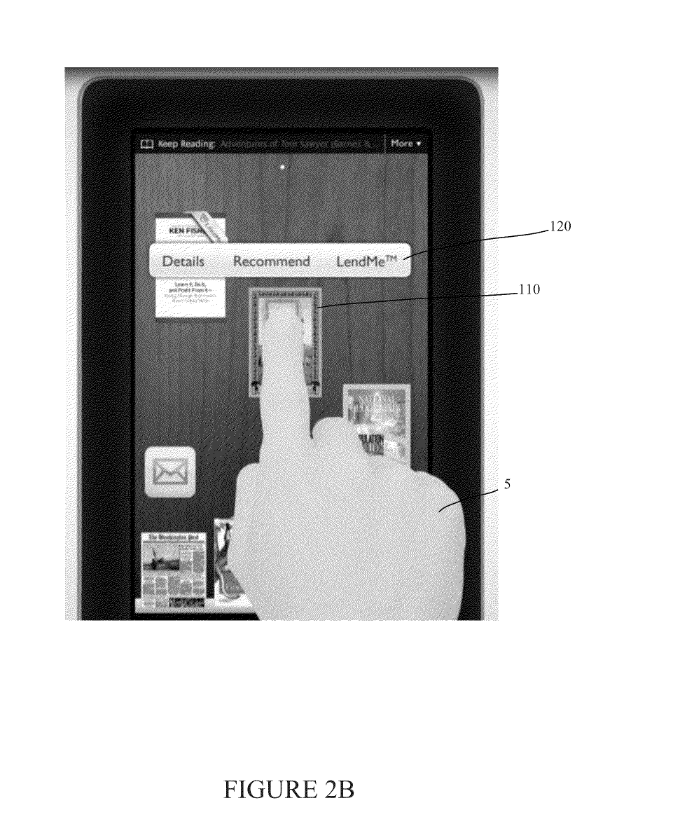

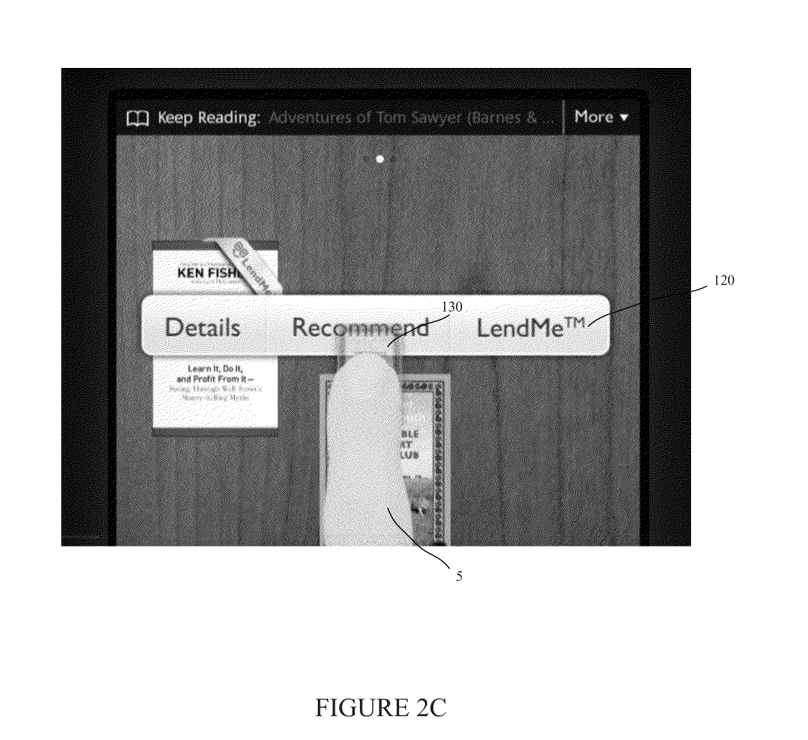

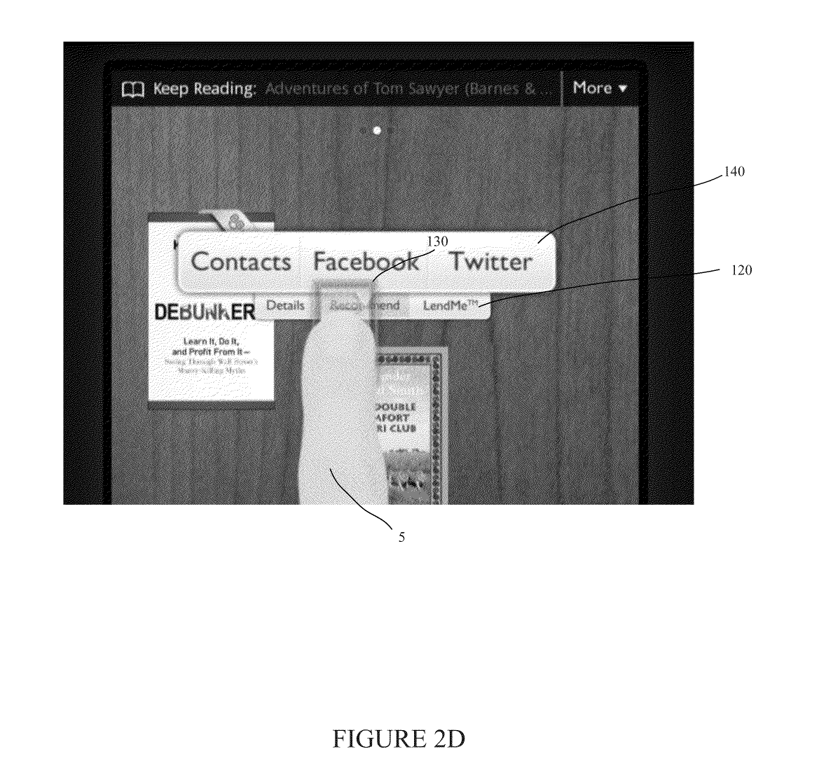

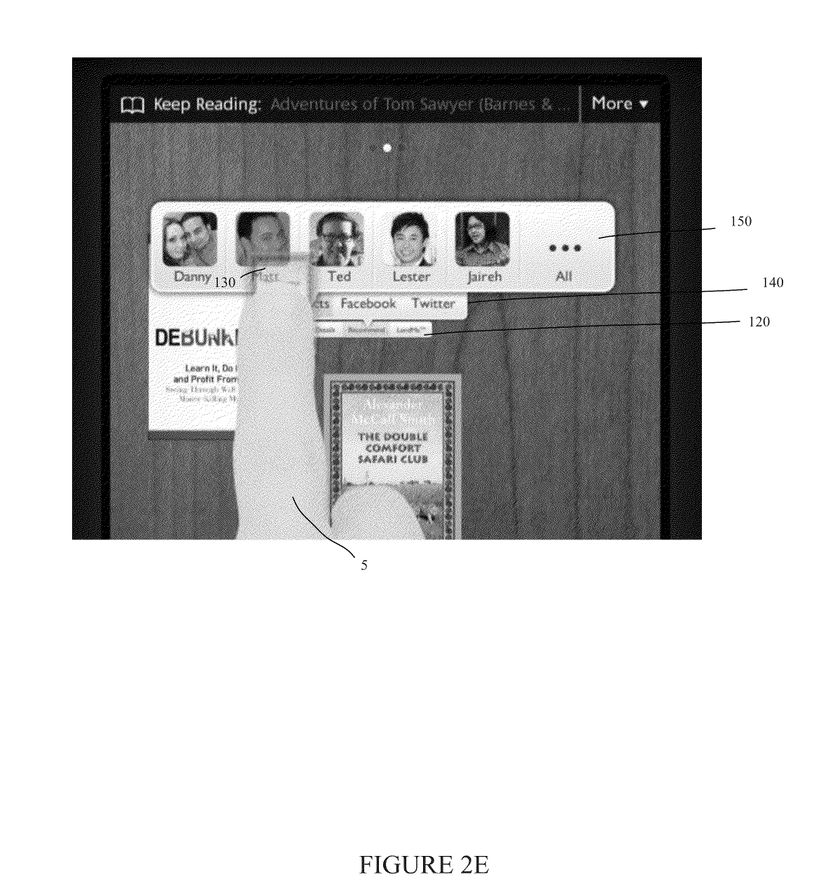

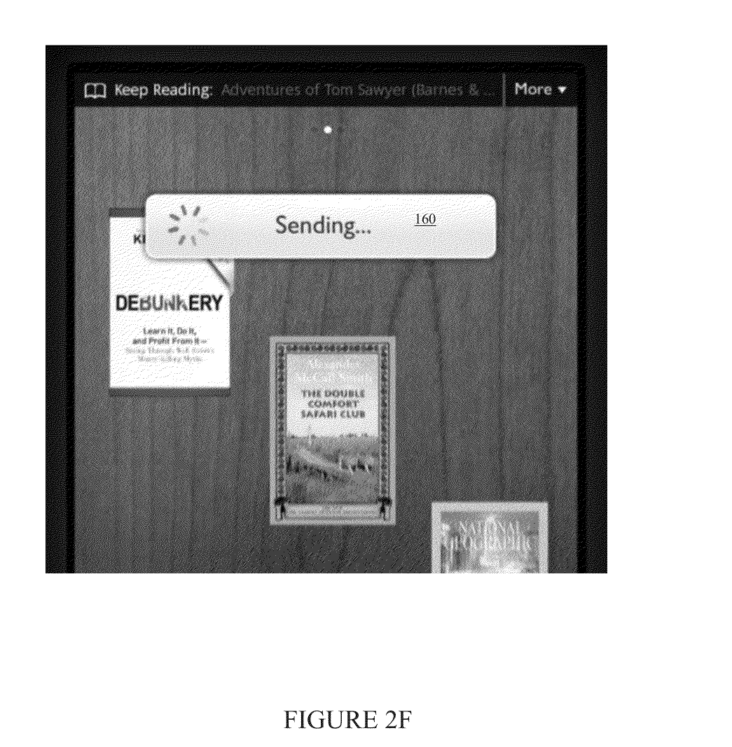

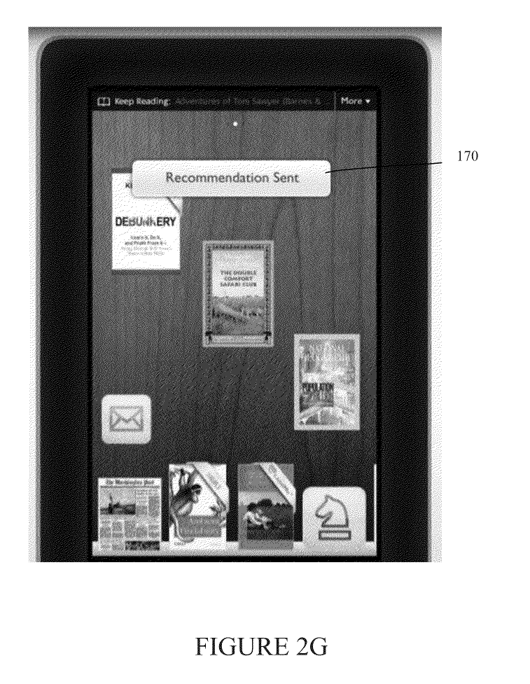

FIGS. 2A-2F illustrate a further example of the present invention. The example illustrated in FIGS. 2A-2F is for recommending an eBook to user's contact. A cover icon 110 representing an eBook is displayed on the desktop/homepage 105 of a user's device 100. As described above, the user can select the eBook by tapping on the icon 110. As shown in FIG. 2B, as the user 5 presses her finger on the selected item 110, a first menu/row/bubbles 120 of options is displayed. In the example illustrated in these FIGS. 2A-2E with respect to the eBook 110, the “Details” of the eBook 110 can be displayed or the user can “Recommend” or “Lend” the eBook 110 to others.

As with the examples described above in FIG. 1A-1E, the user has the option of entering the drag-through-options mode or the tap-through-options mode. If the user lifts her finger after the display of the first row of option bubbles, the system enters the tap-though-options mode. If the user drags the selected item some distance, e.g., 1/10th of an inch, the system enters the drag-through-options mode.

As further shown in FIG. 2C, as the first layer of action bubbles 120 appears, a reduced icon 130 representing the eBook is displayed. As shown in FIG. 2D, the user has hovered, paused, over the “Recommend” option on menu 120 and the row 140 of sub options is displayed. At the same time as the new option bubble row 140 appears, the original row 120 is shrunk in size. In the particular “Recommend” example illustrated in these Figures, the user 5 can recommend the selected eBook, through her contacts list, through Facebook™ or through Twitter™. As shown in FIG. 2E, the user has selected to recommend the eBook 110 via Facebook™ and a row 150 of the user's Facebook™ “friends”/user IDs appears. The user can then drag the eBook icon 130, which represents the eBook she wants to recommend, to any of her Facebook™ friends. In FIG. 2F, the system indicates via message 160 that it is posting the recommendation on the selected friend's wall, and in FIG. 2G indicates via message 170 that the recommendation post has been completed.

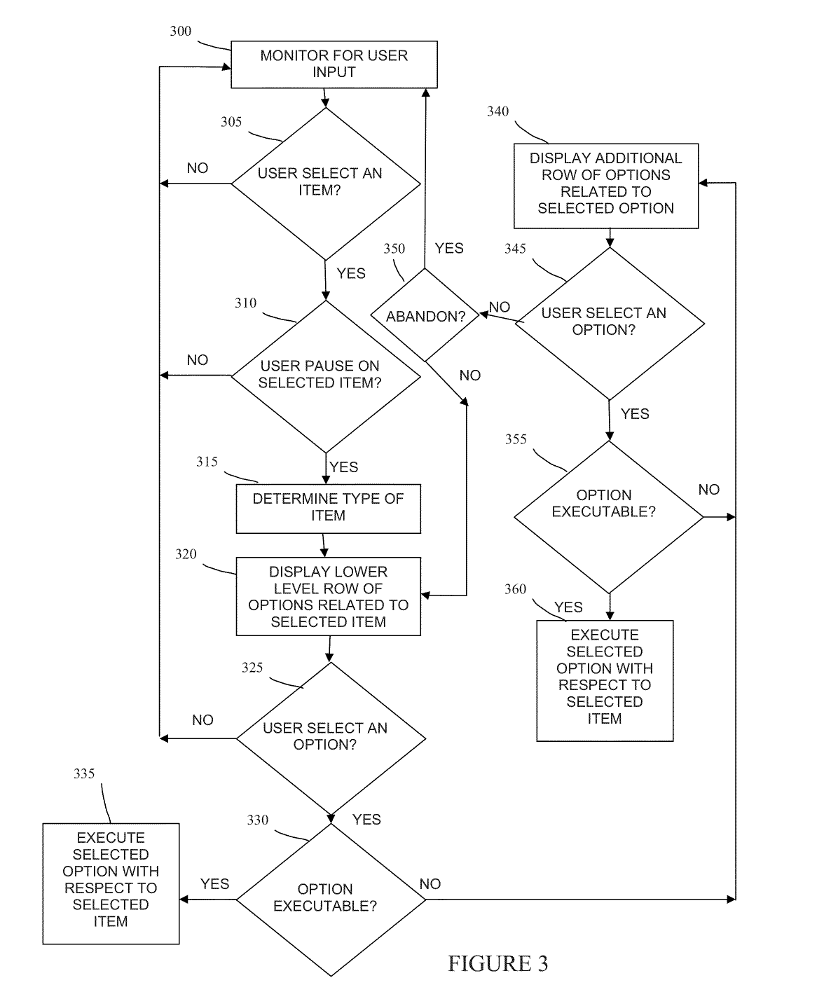

FIG. 3 is a flow chart describing the basic operation of the present invention, for either the drag-though or tap-though embodiments. In act 300, the system is monitoring for user input, specifically for the user to select an item, e.g., a section of text, an eBook, a file . . . Again, in the preferred embodiment this monitoring is performed with respect to a touch sensitive surface of the device, e.g., a touch screen. In act 305, the system has detected a user's input and tests whether the input is the selection of an item. If the input is not the selection of an item, the system goes back to monitoring for input from the user in act 300. If the user has selected an item, the system in act 310 determines if the user has paused her touch on the item for some period of time as described above. If the user has selected an item but does not pause her touch on the selected item, the system again goes back to monitoring for input from the user in act 300. If the user does pause on the selected item, the system interprets this pause as a command to enter either the drag-through or tap through modes of the present invention.

In act 315, the system determines the type of item that the user has selected. This determination is performed so that in act 320, the system can display the types of options in a menu row that are appropriate to the type of selected item. In the preferred embodiment, the correlation between the options that are displayed and the type of item are predetermined. In action 325, the system monitors for further user input, specifically the selection of one of the options in the displayed menu row. If the user does not make a selection of one of the options, e.g., lifts her finger off the screen in the drag-through mode or taps elsewhere in the tap-through mode, the system interprets this as an intent by the user to abandon the operation with respect to the selected item and returns to the monitoring in act 300.

If the user selects an option on the current level, row, of menu options, e.g. by “dropping” the selected item on the option, pausing on the option or tapping on the option, the system then determines in act 330 if the option represents a executable function with respect to the selected item. If the option is an executable function, e.g., ‘print this file’, the system in act 335 executes the function in step 335. If the option is not executable by itself, it is because further information about the action the user wants to perform is required to be gathered, which the system does in act 340 by displaying a further row, menu, of options to the user.

As with act 325, in act 345, the system looks to see if the user selects of one of the options in the higher level menu row. If the user does not make a selection of one of the options, e.g., lifts her finger off the screen the drag-through mode or taps elsewhere in the tap-through mode, the system in act 350 interprets this as an intent by the user to abandon the operation with respect to the selected item and returns to the monitoring in act 300. If the user doesn't select an option on the higher level row, but moved back down toward, or taps on the lower level row, the system interprets this as an intent by the user to re-think her selection in the lower level row. In this case, the higher level row is no longer displayed and the user can select another option on the lower level row. In the embodiment of the present invention described above where the lower level row had been shrunken in size, it is returned to it's original size in act 320.

If the user does select an option on the higher level row of menu options, e.g. by “dropping” the selected item on the option, pausing on the option or tapping on the option, the system in act 355 determines if the option represents a executable function with respect to the selected item. If the option is an executable function, e.g., ‘share this selected text to my Facebook™ page’, the system in act 360 executes the function. If there is still more information that the system needs to gather in order to determine the executable function the user wants to perform with respect to the selected item, the system can iteratively display additional levels of menus of option in acts 340-360.

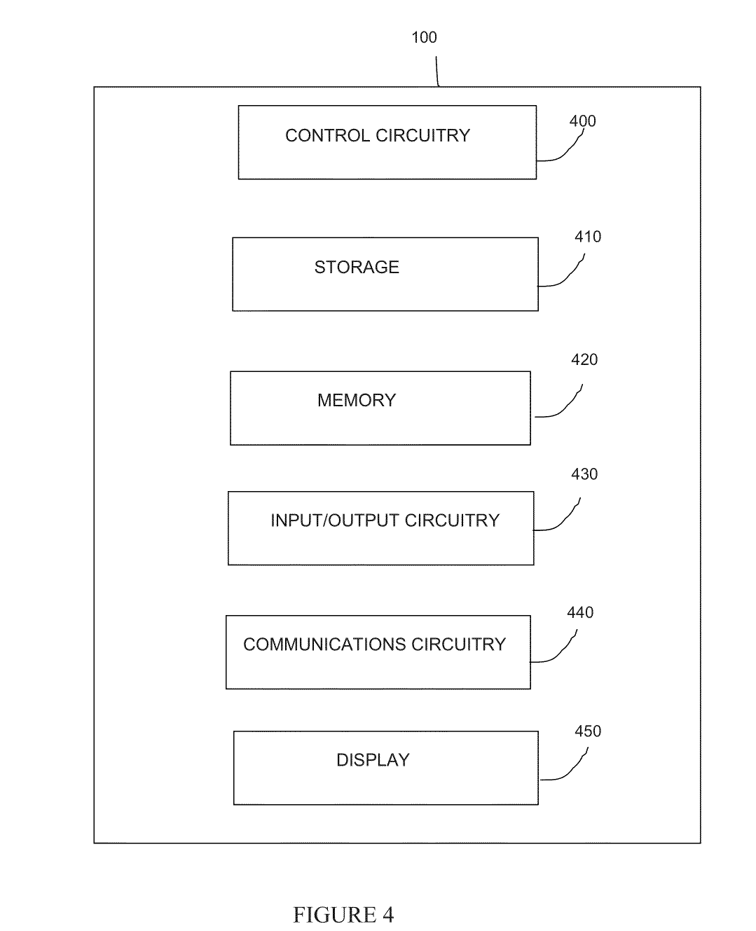

FIG. 4 illustrates an exemplary device 100 for operating the present invention. As appreciated by those skilled the art, the device 100 can take many forms capable of operating the present invention. In a preferred embodiment the device 100 is a mobile electronic device, and in an even more preferred embodiment device 100 is an electronic reader device. Electronic device 100 can include control circuitry 400, storage 410, memory 420, input/output (“I/O”) circuitry 430, communications circuitry 440, and display 450. In some embodiments, one or more of the components of electronic device 100 can be combined or omitted, e.g., storage 410 and memory 420 may be combined. As appreciated by those skilled in the art, electronic device 100 can include other components not combined or included in those shown in this Figure, e.g., a power supply such as a battery, an input mechanism, etc.

Electronic device 100 can include any suitable type of electronic device. For example, electronic device 100 can include a portable electronic device that the user may hold in his or her hand, such as a digital media player, a personal e-mail device, a personal data assistant (“PDA”), a cellular telephone, a handheld gaming device, a tablet device or an eBook reader. As another example, electronic device 100 can include a larger portable electronic device, such as a laptop computer. As yet another example, electronic device 100 can include a substantially fixed electronic device, such as a desktop computer.

Control circuitry 400 can include any processing circuitry or processor operative to control the operations and performance of electronic device 100. For example, control circuitry 400 can be used to run operating system applications, firmware applications, media playback applications, media editing applications, or any other application. Control circuitry 400 can drive the display 450 and process inputs received from a user interface, e.g., the touch screen portion of display 450.

Storage 410 can include, for example, one or more computer readable storage mediums including a hard-drive, solid state drive, flash memory, permanent memory such as ROM, magnetic, optical, semiconductor, paper, or any other suitable type of storage component, or any combination thereof. Storage 410 can store, for example, media content, eBooks, music and video files, application data, e.g., software for implementing functions on electronic device 100, firmware, user preference information data, e.g., content preferences, authentication information, e.g., libraries of data associated with authorized users, transaction information data, e.g., information such as credit card information, wireless connection information data, e.g., information that can enable electronic device 100 to establish a wireless connection, subscription information data, e.g., information that keeps track of podcasts or television shows or other media a user subscribes to, contact information data, e.g., telephone numbers and email addresses, calendar information data, and any other suitable data or any combination thereof. The instructions for implementing the functions of the present invention may, as non-limiting examples, comprise software and/or scripts stored in the computer-readable media 410.

Memory 420 can include cache memory, semi-permanent memory such as RAM, and/or one or more different types of memory used for temporarily storing data. In some embodiments, memory 420 can also be used for storing data used to operate electronic device applications, or any other type of data that can be stored in storage 410. In some embodiments, memory 420 and storage 410 can be combined as a single storage medium.

I/O circuitry 430 can be operative to convert, and encode/decode, if necessary analog signals and other signals into digital data. In some embodiments, I/O circuitry 430 can also convert digital data into any other type of signal, and vice-versa. For example, I/O circuitry 430 can receive and convert physical contact inputs, e.g., from a multi-touch screen, i.e., display 450, physical movements, e.g., from a mouse or sensor, analog audio signals, e.g., from a microphone, or any other input. The digital data can be provided to and received from control circuitry 400, storage 410, and memory 420, or any other component of electronic device 100. Although I/O circuitry 430 is illustrated in this Figure as a single component of electronic device 100, several instances of I/O circuitry 430 can be included in electronic device 100.

Electronic device 100 can include any suitable interface or component for allowing a user to provide inputs to I/O circuitry 430. For example, electronic device 100 can include any suitable input mechanism, such as a button, keypad, dial, a click wheel, or a touch screen, e.g., display 450. In some embodiments, electronic device 100 can include a capacitive sensing mechanism, or a multi-touch capacitive sensing mechanism.

In some embodiments, electronic device 100 can include specialized output circuitry associated with output devices such as, for example, one or more audio outputs. The audio output can include one or more speakers, e.g., mono or stereo speakers, built into electronic device 100, or an audio component that is remotely coupled to electronic device 100, e.g., a headset, headphones or earbuds that can be coupled to device 100 with a wire or wirelessly.

Display 450 includes the display and display circuitry for providing a display visible to the user. For example, the display circuitry can include a screen, e.g., an LCD screen, that is incorporated in electronics device 100. In some embodiments, the display circuitry can include a coder/decoder (Codec) to convert digital media data into analog signals. For example, the display circuitry or other appropriate circuitry within electronic device 100 can include video Codecs, audio Codecs, or any other suitable type of Codec.

The display circuitry also can include display driver circuitry, circuitry for driving display drivers, or both. The display circuitry can be operative to display content, e.g., media playback information, application screens for applications implemented on the electronic device 100, information regarding ongoing communications operations, information regarding incoming communications requests, or device operation screens, under the direction of control circuitry 400. Alternatively, the display circuitry can be operative to provide instructions to a remote display.

Communications circuitry 440 can include any suitable communications circuitry operative to connect to a communications network and to transmit communications, e.g., data from electronic device 100 to other devices within the communications network. Communications circuitry 440 can be operative to interface with the communications network using any suitable communications protocol such as, for example, Wi-Fi, e.g., a 802.11 protocol, Bluetooth, radio frequency systems, e.g., 900 MHz, 1.4 GHz, and 5.6 GHz communication systems, infrared, GSM, GSM plus EDGE, CDMA, quadband, and other cellular protocols, VOIP, or any other suitable protocol.

Electronic device 100 can include one more instances of communications circuitry 440 for simultaneously performing several communications operations using different communications networks, although only one is shown in this Figure to avoid overcomplicating the drawing. For example, electronic device 100 can include a first instance of communications circuitry 440 for communicating over a cellular network, and a second instance of communications circuitry 440 for communicating over Wi-Fi or using Bluetooth. In some embodiments, the same instance of communications circuitry 440 can be operative to provide for communications over several communications networks.

In some embodiments, electronic device 100 can be coupled to a host device such as remote servers for data transfers, synching the communications device, software or firmware updates, providing performance information to a remote source, e.g., providing reading characteristics to a remote server, or performing any other suitable operation that can require electronic device 100 to be coupled to a host device. Several electronic devices 100 can be coupled to a single host device using the host device as a server. Alternatively or additionally, electronic device 100 can be coupled to several host devices, e.g., for each of the plurality of the host devices to serve as a backup for data stored in electronic device 100.

Although the present invention has been described in relation to particular embodiments thereof, many other variations and other uses will be apparent to those skilled in the art, it is preferred, therefore, that the present invention be limited not by the specific disclosure herein, but only by the gist and scope of the disclosure.

What is claimed is:

1. A method for facilitating the execution of functions on an electronic device comprising:
displaying items on a display screen of the electronic device;
detecting a first action of selecting one of the displayed items;
detecting a second action of pausing on selected item;
displaying a first menu of options on the display screen above the selected item;
detecting a third action of selecting one of the options on the first menu of options;
displaying a second menu of options in response to the detection of the third action, the second menu of options being related to the selected option on the first menu of options, the second menu of options being displayed above the first menu of options;
detecting a fourth action of selecting one of the options on the second menu of options; and
executing a function corresponding to the selected option on the second menu with respect to the selected item.

2. The method according to claim 1, further comprising reducing a size of first menu of options on the display screen after the detection of the third action.

3. The method according to claim 1, wherein the act of displaying items further includes displaying text and files.

4. The method according to claim 1, wherein the electronic device includes a touchscreen and the acts of detecting further comprising detecting a user's action on the touchscreen.

5. The method according to claim 1, further comprising displaying an icon representing the selected item.

6. The method according to claim 5, wherein the act of detecting the third action further comprises detecting the icon of the selected item being dragged to the selected option on the first menu of options.

7. The method according to claim 5, wherein the act of detecting the fourth action further comprises detecting the icon of the selected item being dragged to the selected option on the second menu of options.

8. The method according to claim 7, further comprising:
detecting a fifth action dragging the icon of the selected item off of the selected option on the second menu of options; and
removing the display of the second menu of options.

9. The method according to claim 7, further comprising:
reducing a size of first menu of options on the display screen after the detection of the third action;
detecting a fifth action dragging the icon of the selected item off of the selected option on the second menu of options;
removing the display of the second menu of options; and
restoring the size of the first menu of options to its original size.

10. The method according to claim 1, wherein the act of detecting the third action further comprises detecting the selected option being tapped on a touch screen device.

11. The method according to claim 1, wherein the act of detecting third action further comprises detecting the user clicking on the selected option using an input device.

12. A non-transitory computer-readable media comprising a plurality of instructions that, when executed by at least one electronic device, cause the at least one electronic device to:
display items on a display screen of the at least one electronic device;
detect a first selection one of the displayed items;
detecting an action of pausing on selected item;
display a first menu of options on the display screen above the selected item;
detect a second selection of one of the options on the first menu of options;
display a second menu of options in response to the detection of the second selection, the second menu of options being related to the selected option on the first menu of options, the second menu of options being displayed above the first menu of options;
detect a third selection one of the options on the second menu of options; and
execute a function corresponding to the selected option on the second menu with respect to the selected item.

13. A system for facilitating the execution of functions on an electronic device comprising:
a memory that includes instructions for operating the electronic device and includes items that are capable of being displayed on the electronic device;
a display;
a touch sensitive input device; and
control circuitry coupled to the memory, coupled to the touch sensitive input device and coupled to the display, the control circuitry executing the instructions and is operable to:
display items on the display;
detect, using the input device, a selection of one of the displayed items;
display a first menu of options on the display;
detect, through input received from the touch sensitive input device, a selection of one of the options on the first menu of options;
display a second menu of options on the display in response to the detection of the selection of one of the options on the first menu of options, the second menu of options being related to the selected option on the first menu of options;
detect, through input received from the touch sensitive input device, a selection one of the options on the second menu of options; and
execute a function corresponding to the selected option on the second menu with respect to the selected item.

14. The system according to claim 13, wherein the control circuitry is operable to reduce a size of first menu of options on the display screen after the detection of the third action.

15. The system according to claim 13, wherein displayed items includes text and files.

16. The system according to claim 13, wherein touch sensitive input device is a touchscreen and wherein the control circuitry is operable to detect a user's action on the touchscreen.

17. The system according to claim 13, wherein the control circuitry is further operable to display an icon representing the selected item.

18. The system according to claim 17, wherein the control circuitry is operable to detect the third action by detecting the icon of the selected item being dragged to the selected option on the first menu of options.

19. The system according to claim 18, wherein the control circuitry is operable to detect the fourth action by detecting the icon of the selected item being dragged to the selected option on the second menu of options.

20. The system according to claim 19, wherein the control circuitry is further operable to:
detecting a fifth action dragging the icon of the selected item off of the selected option on the second menu of options; and
remove the display of the second menu of options.

21. The system according to claim 19, wherein the control circuitry is further operable to:
reduce a size of first menu of options on the display screen after the detection of the third action;
detect a fifth action dragging the icon of the selected item off of the selected option on the second menu of options;
remove the display of the second menu of options; and
restore the size of the first menu of options to its original size.

22. The method according to claim 13, wherein the control circuitry is operable to detect the third action by detecting the selected option being tapped on a touch screen device.

23. The system according to claim 13, wherein the control circuitry is operable to detect the third action by detecting the user clicking on the selected option using an input device.
